(19) United States
(12) Patent Application Publication
(10) Pub. No.: US 2025/0208335 A1
(43) Pub. Date: Jun. 26, 2025

(54) LIGHT SOURCE MODULE AND DISPLAY DEVICE

(71) Applicant: E Ink Holdings Inc., Hsinchu (TW)

(72) Inventors: Kun-Hsien Lee, Hsinchu (TW); Ching-Huan Liao, Hsinchu (TW); Hsin-Tao Huang, Hsinchu (TW)

(73) Assignee: E Ink Holdings Inc., Hsinchu (TW)

(21) Appl. No.: 18/954,438

(22) Filed: Nov. 20, 2024

(30) Foreign Application Priority Data
Dec. 22, 2023 (TW) 112150252

(51) Int. Cl. F21V 8/00

(52) U.S. Cl. CPC G02B 6/0088; G02B 6/0043; G02B 6/0091

(57) ABSTRACT

A light source module includes a light guide plate and a light source. The light guide plate includes a first light guide layer, a second light guide layer, and a translucent adhesive layer. The second light guide layer is bonded to the first light guide layer through the translucent adhesive layer. An absolute value of a refractive index difference between the translucent adhesive layer and any one of the first light guide layer and the second light guide layer is less than or equal to 0.02. The light source is disposed adjacent to a side surface of the light guide plate.

### CROSS-REFERENCE TO RELATED APPLICATION

This application claims the priority benefit of Taiwan application serial no. 112150252, filed on Dec. 22, 2023. The entirety of the above-mentioned patent application is hereby incorporated by reference herein and made a part of this specification.

### BACKGROUND

### Technical Field

The disclosure relates to a module and a device, and in particular to a light source module and a display device.

### Description of Related Art

The development of light source modules and display devices has gradually matured, but there are still some problems (such as light extraction efficiency and stress) that need to be improved.

### SUMMARY

The disclosure provides a light source module and a display device, which help improve at least one of the above problems.

A light source module of the disclosure includes a light guide plate and a light source. The light guide plate includes a first light guide layer, a second light guide layer, and a translucent adhesive layer. The second light guide layer is bonded to the first light guide layer through the translucent adhesive layer. An absolute value of a refractive index difference between the translucent adhesive layer and any one of the first light guide layer and the second light guide layer is less than or equal to 0.02. The light source is disposed adjacent to a side surface of the light guide plate.

A display device of the disclosure includes a display panel and a light source module. The light source module is disposed on the display panel and includes a light guide plate and a light source. The light guide plate includes a first light guide layer, a second light guide layer, and a translucent adhesive layer. The second light guide layer is bonded to the first light guide layer through the translucent adhesive layer. An absolute value of a refractive index difference between the translucent adhesive layer and any one of the first light guide layer and the second light guide layer is less than or equal to 0.02. The light source is disposed adjacent to a side surface of the light guide plate.

In an embodiment of the disclosure, a storage modulus of the translucent adhesive layer is less than 60 kPa.

In an embodiment of the disclosure, a thickness of the translucent adhesive layer is 25 μm to 75 μm.

In an embodiment of the disclosure, a material of the translucent adhesive layer includes optical clear adhesive or optical clear resin.

In an embodiment of the disclosure, a thickness of the light guide plate is less than a thickness of the light source.

In an embodiment of the disclosure, a plurality of microstructures are formed on a surface of the second light guide layer away from the translucent adhesive layer.

In an embodiment of the disclosure, the first light guide layer, the second light guide layer, and the translucent adhesive layer have the same area.

In order to make the above-mentioned features and advantages of the disclosure more comprehensible, the embodiments are specifically mentioned below and described in detail with reference to the accompanying drawings.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a partial cross-sectional schematic view of a light source module according to an embodiment of the disclosure.

FIG. 2 is a partial cross-sectional schematic view of a display device according to an embodiment of the disclosure.

### DESCRIPTION OF THE EMBODIMENTS

Directional terms mentioned throughout the specification, such as “up”, “down”, “front”, “back”, “left”, and “right”, are merely for reference to the direction in the accompanying drawings. Therefore, the directional terms used are for illustration and not for limiting the disclosure.

In the accompanying drawings, each drawing illustrates the general features of a method, a structure, or a material used in a specific embodiment. However, the drawings should not be construed as defining or limiting the scope or nature covered by the embodiments. For example, the relative size, thickness, and location of various layers, regions, or structures may be reduced or enlarged for clarity.

In the drawings, the same or similar elements are given the same or similar reference numerals, and repeated description thereof will be omitted in the specification. In addition, wherever no conflict is present, features in different embodiments may be combined with each other, and simple equivalent changes and modifications made in accordance with the specification or the appended claims are still within the scope of the disclosure.

The terms “first” and “second” mentioned in the specification or claims are merely used to name different elements or to distinguish different embodiments or ranges, and are not used to limit the upper limit or lower limit of the number of elements, nor to limit the manufactured order or the disposed order of elements. In addition, an element/film layer disposed on (or above) another element/film layer may include a situation that the element/film layer is directly disposed on (or above) the other element/film layer, and the two elements/film layers are in direct contact; and a situation that the element/film layer is indirectly disposed on (or above) the other element/film layer, and there are one or more elements/film layers between the two elements/film layers.

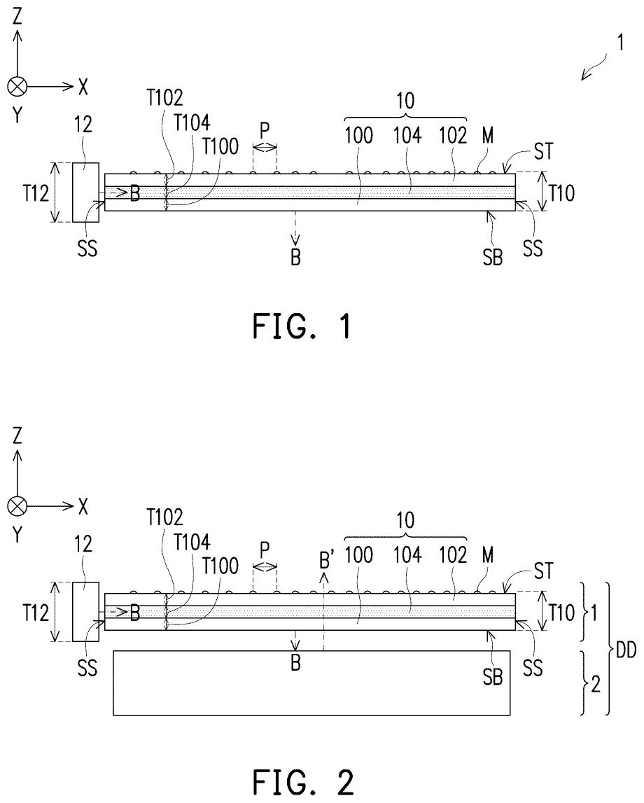

FIG. 1 is a partial cross-sectional schematic view of a light source module according to an embodiment of the disclosure. Referring to FIG. 1, a light source module 1 may include a light guide plate 10 and a light source 12. The light guide plate 10 may include a first light guide layer 100, a second light guide layer 102, and a translucent adhesive layer 104. The second light guide layer 102 is bonded to the first light guide layer 100 through the translucent adhesive layer 104. An absolute value of a refractive index difference between the translucent adhesive layer 104 and any one of the first light guide layer 100 and the second light guide layer 102 is less than or equal to 0.02. A light source 12 is disposed adjacent to a side surface SS of the light guide plate 10.

In detail, as shown in FIG. 1, the light guide plate 10 may be a composite light guide plate formed by alternately stacking multiple light guide layers (such as the first light guide layer 100 and the second light guide layer 102) and at least one translucent adhesive layer (such as the translucent adhesive layer 104) along a thickness direction (such as a direction Z) of the light source module 1. The material of the multiple light guide layers (including the first light guide layer 100 and the second light guide layer 102) includes, for example, plastic, such as polymethyl methacrylate (PMMA) or polycarbonate (PC), but is not limited thereto. The material of the translucent adhesive layer (including the translucent adhesive layer 104) includes, for example, a sticky and light transmitting material, such optical clear adhesive (OCA) or optical clear resin (OCR), but is not limited thereto.

The shape of the light guide plate 10 may be formed in a plate shape. Taking a rectangular plate as an example, the light guide plate 10 may have a top surface ST, a bottom surface SB, and four side surfaces SS, in which the top surface ST is opposite to the bottom surface SB, and the four side surface SS are located around the top surface ST/bottom surface SB respectively and connect the top surface ST with the bottom surface SB. The top surface ST is, for example, the surface of the second light guide layer 102 away from the translucent adhesive layer 104, the bottom surface SB is, for example, the surface of the first light guide layer 100 away from the translucent adhesive layer 104, and each side surface SS comprises side wall surfaces of the first light guide layer 100, the translucent adhesive layer 104, and the second light guide layer 102 on the same side.

The light source 12 is disposed adjacent to at least one of the multiple side surfaces SS of the light guide plate 10. Taking a single-side light source module as an example, the light source 12 may be disposed adjacent to a side surface SS of the light guide plate 10. Taking a multi-side light source module as an example, the light source 12 may be disposed adjacent to multiple side surfaces SS of the light guide plate 10. In some embodiments, although not shown, the light source 12 may include multiple light-emitting diodes. In the structure of FIG. 1, multiple light-emitting diodes may be arranged along a direction Y next to the side surface SS of the light guide plate 10, but is not limited thereto.

A beam B emitted by the light source 12 may enter the light guide plate 10 through the side surface SS of the light guide plate 10, and the beam B entering the light guide plate 10 may be transmitted toward the direction (such as a direction X) away from the light source 12 in a manner of total internal reflection (TIR). One of the top surface ST and the bottom surface SB of the light guide plate 10 may be formed with multiple microstructures M to destroy the total internal reflection, so that the beam B may emit out of the light guide plate 10. The plurality of microstructures M may be protruded or recessed on one of the top surface ST and the bottom surface SB of the light guide plate 10. Taking a front light module as an example, as shown in FIG. 1, the top surface ST of the light guide plate 10 (such as the surface of the second light guide layer 102 away from the translucent adhesive layer 104) may be formed with the multiple microstructures M, so that the beam B may emit out of the light guide plate 10 from the bottom surface SB of the light guide plate 10. Taking a backlight module as an example, although not shown, the bottom surface SB of the light guide plate 10 (such as the surface of the first light guide layer 100 away from the translucent adhesive layer 104) may be formed with multiple microstructures M, so that the beam B may emit out of the light guide plate 10 from the top surface ST of the light guide plate 10.

In some embodiments, pitches P of the multiple microstructures M may decrease toward the direction (such as the direction X) away from the light source 12 to improve the uniformity of light emission in the direction X, but is not limited thereto. In some embodiments, although not shown, the multiple microstructures M may be arranged staggeredly in the direction Y to improve the uniformity of light emission in the direction Y, but is not limited thereto.

In some embodiments, the light source module 1 may be a foldable light source module or a rollable light source module. In the embodiments, a thickness (such as a thickness T100 and a thickness T102) of the multiple light guide layers (including the first light guide layer 100 and the second light guide layer 102) may be reduced to less than 400 μm (such as 100 μm or 50 μm, but is not limited thereto) to facilitate folding or rolling. In addition, a thickness T104 of the translucent adhesive layer 104 may be 25 μm to 75 μm, that is, 25 μm≤T104≤75 μm, in order to take into account both adhesion and flexibility (such as folding or rolling) characteristics. A storage modulus of the translucent adhesive layer 104 is, for example, less than 60 kPa, to facilitate folding or rolling.

A thickness T10 of the light guide plate 10 becomes low as the thickness of the multiple light guide layers and/or translucent adhesive layer decreases. On the other hand, due to conventional packaging design or yield considerations, the thinning of the light source 12 is limited, so the thickness T10 of the light guide plate 10 may be less than the thickness T12 of the light source 12. When the thickness T10 of the light guide plate 10 is less than the thickness T12 of the light source 12, the lower the thickness T10 of the light guide plate 10, the lower the light coupling efficiency, that is, the less beam B enters the light guide plate 10. Compared with using a single thinned light guide layer, increasing the number of light guide layers can improve the light coupling efficiency.

Two adjacent light guide layers (including the first light guide layer 100 and the second light guide layer 102) may be fixed together via the translucent adhesive layer (including the translucent adhesive layer 104). The translucent adhesive layer can reduce the shading of the beam B and may be used as a buffer layer to reduce stress when folded or rolled.

In some embodiments, as shown in FIG. 1, the multiple light guide layers (including the first light guide layer 100 and the second light guide layer 102) and the translucent adhesive layer (including the translucent adhesive layer 104) in the light guide plate 10 may have the same orthogonal projection. For example, the orthogonal projections of the first light guide layer 100, the second light guide layer 102, and the translucent adhesive layer 104 on a XY plane formed by the direction X and the direction Y may be the same, so that the first light guide layer 100 and the second light guide layer 102 may be fully laminated.

Under the fully laminated structure, the refractive index of the translucent adhesive layer 104 may match the refractive index of any one of the first light guide layer 100 and the second light guide layer 102 to improve the light extraction efficiency, light output brightness, and/or contrast of the light source module 1. The refractive index of the translucent adhesive layer 104 matching the refractive index of any one of the first light guide layer 100 and the second light guide layer 102 means that the refractive index of the translucent adhesive layer 104 is the same or similar to the refractive index of any one of the first light guide layer 100 and the second light guide layer 102. The refractive index being similar means that an absolute value of a refractive index difference is less than or equal to 0.02. If the refractive index of the first light guide layer 100 is n1, the refractive index of the second light guide layer 102 is n2, and the refractive index of the translucent adhesive layer 104 is n3, then |n3−n1|≤0.02 means that the refractive index of the translucent adhesive layer 104 matches/is similar to the refractive index of first light guide layer 100, and |n3−n2|≤0.02 means that the refractive index of the translucent adhesive layer 104 matches/is similar to the refractive index of the second light guide layer 102.

In other embodiments, although not shown, the light guide plate 10 may include more light guide layers and more translucent adhesive layers. For example, the light guide plate may include N light guide layers and (N−1) translucent adhesive layers alternately stacked in the direction Z, in which N may be a positive integer greater than 2.

In other embodiments, although not shown, the light source module 1 may further include other elements or film layers, such as one or more optical films, but is not limited thereto.

FIG. 2 is a partial cross-sectional schematic view of a display device according to an embodiment of the disclosure. Please refer to FIG. 2. A display device DD may include a display panel 2 and the light source module 1. The light source module 1 is disposed on the display panel 2 and may include the light guide plate 10 and the light source 12. The light guide plate 10 may include the first light guide layer 100, the second light guide layer 102, and the translucent adhesive layer 104. The second light guide layer 102 is bonded to the first light guide layer 100 through the translucent adhesive layer 104. The absolute value of the refractive index difference between the translucent adhesive layer 104 and any one of the first light guide layer 100 and the second light guide layer 102 is less than or equal to 0.02. The light source 12 is disposed adjacent to the side surface SS of the light guide plate 10.

As shown in FIG. 2, the light source module 1 is, for example, a side-light-type front light module, in which the beam B from the light source 12 enters the light guide plate 10 through the side surface SS of the light guide plate 10, and the beam B is transmitted toward the direction (such as the direction X) away from the light source 12 in a manner of total internal reflection (TIR). The multiple microstructures M located on the top surface ST of the light guide plate 10 destroy the total internal reflection, so that the beam B emits out of the light guide plate 10 from the bottom surface SB of the light guide plate 10 and is transmitted toward the display panel 2 positioned below the light source module 1. The display side of the display panel 2 (that is, the side where the display panel 2 provides images) faces the light source module 1. The beam B emitted to the display panel 2 is converted into a display beam B′ (for example, a beam with grayscale and/or color information) by the display panel 2. The display beam B′is reflected back to the light source module 1 by the display panel 2 and then penetrates the light source module 1 and emits from the display device DD. Using the translucent adhesive layer 104 to bond the first light guide layer 100 and the second light guide layer 102 can reduce the shielding of the display beam B′ by the translucent adhesive layer 104. The display panel 2 may include a reflective display panel (such as an electrophoretic display panel, but is not limited thereto) or a partially penetrating and partially reflective display panel, but is not limited thereto.

When the material of the substrate (not shown) in the display panel 2 is different from the material of the light guide layer (such as the first light guide layer 100 and the second light guide layer 102) in the light guide plate 10, for example, when the substrate in the display panel 2 is a glass substrate and the light guide layer in the light guide plate 10 is a plastic light guide layer, warpage problems caused by thermal expansion coefficient mismatch are likely to occur. Through the design of multiple light guide layers and at least one translucent adhesive layer, the translucent adhesive layer can be used as a buffer layer to reduce the stress during warping. In addition, when the display device DD is a foldable display device or a rolled display device, the translucent adhesive layer can also be used as a buffer layer to reduce stress when folded or rolled.

In summary, in the embodiments of the disclosure, the stress can be reduced through the design of multiple light guide layers and at least one translucent adhesive layer, and the light extraction efficiency, light output brightness, and/or contrast can be improved through the design of the refractive index of the light guide layer matching the refractive index of the translucent adhesive layer.

Although the disclosure has been disclosed above in the embodiments, the embodiments are not intended to limit the disclosure. Persons with ordinary knowledge in the technical field may make some modifications and modifications without departing from the spirit and scope of the disclosure. Therefore, the protection scope of the disclosure shall be determined by the appended claims.

What is claimed is:

1. A light source module, comprising:
a light guide plate comprising a first light guide layer, a second light guide layer, and a translucent adhesive layer, wherein the second light guide layer is bonded to the first light guide layer through the translucent adhesive layer, and an absolute value of a refractive index difference between the translucent adhesive layer and any one of the first light guide layer and the second light guide layer is less than or equal to 0.02; and
a light source disposed adjacent to a side surface of the light guide plate.

2. The light source module as claimed in claim 1, wherein a storage modulus of the translucent adhesive layer is less than 60 kPa.

3. The light source module as claimed in claim 1, wherein a thickness of the translucent adhesive layer is 25 μm to 75 μm.

4. The light source module as claimed in claim 1, wherein a material of the translucent adhesive layer comprises optical clear adhesive or optical clear resin.

5. The light source module as claimed in claim 1, wherein a thickness of the light guide plate is less than a thickness of the light source.

6. The light source module as claimed in claim 1, wherein a plurality of microstructures are formed on a surface of the second light guide layer away from the translucent adhesive layer.

7. The light source module as claimed in claim 1, wherein the first light guide layer, the second light guide layer, and the translucent adhesive layer have the same orthogonal projection.

8. A display device, comprising:
a display panel; and
a light source module disposed on the display panel and comprising:
a light guide plate comprising a first light guide layer, a second light guide layer, and a translucent adhesive layer, wherein the second light guide layer is bonded to the first light guide layer through the translucent adhesive layer, and an absolute value of a refractive index difference between the translucent adhesive layer and any one of the first light guide layer and the second light guide layer is less than or equal to 0.02; and
a light source disposed adjacent to a side surface of the light guide plate.

9. The display device as claimed in claim 8, wherein a storage modulus of the translucent adhesive layer is less than 60 kPa.

10. The display device as claimed in claim 8, wherein a thickness of the translucent adhesive layer is 25 μm to 75 μm.

11. The display device as claimed in claim 8, wherein a material of the translucent adhesive layer comprises optical clear adhesive or optical clear resin.

12. The display device as claimed in claim 8, wherein a thickness of the light guide plate is less than a thickness of the light source.

13. The display device as claimed in claim 8, wherein a plurality of microstructures are formed on a surface of the second light guide layer away from the translucent adhesive layer.

14. The display device as claimed in claim 8, wherein the first light guide layer, the second light guide layer, and the translucent adhesive layer have the same orthogonal projection.
